(19) United States
(12) Patent Application Publication
(10) Pub. No.: US 2025/0210842 A1
(43) Pub. Date: Jun. 26, 2025

(54) FLEXIBLE CABLES AND WAVEGUIDES

(71) Applicant: SAMTEC, INC., New Albany, IN (US)

(72) Inventors: Kelly GARRISON, New Albany, IN (US); Marc EPITAUX, New Albany, IN (US); Norman Scott MCMORROW, New Albany, IN (US); Sean BARIL, Sherwood, OR (US); Shashi Vashi CHUGANEY, New Albany, IN (US); James Alexander MOSS, New Albany, IN (US)

(21) Appl. No.: 18/851,897

(22) PCT Filed: Mar. 31, 2023
(86) PCT No.: PCT/US2023/017020

§ 371 Date: Sep. 27, 2024

Related U.S. Application Data
(60) Provisional application No. 63/326,769, filed on Apr. 1, 2022.

(51) Int. Cl. H01P 3/16

(52) U.S. Cl. CPC H01P 3/16

(57) ABSTRACT

A signal transmission line, such as a waveguide or electrical cable, can include a spacer that bears against an electrical shield so as to provide enhanced structurally stability and increased signal integrity performance. The waveguide can be a hollow or semi-hollow waveguide. The electrical cable can be a coaxial or twinaxial electrical cable.

### CROSS-REFERENCE TO RELATED APPLICATIONS

This claims priority to U.S. Patent Application Ser. No. 63/326,769 filed Apr. 1, 2022, the disclosure of which is hereby incorporated by reference as if set forth in its entirety herein.

### BACKGROUND

Signal transmission lines can include rf waveguides and electrical cables. RF waveguides typically include a dielectric or hollow channel that is surrounded by an electrical shield. The electrical shield is typically wrapped, for instance helically wrapped about the dielectric. Signal performance of waveguides improves as the cross-sectional shape approaches that of a rectangle. Thus, the dielectric of conventional waveguides can be oval shaped so that the electrical shield wrapped about the dielectric can be under tension, which compresses the electrical shield against the dielectric. In other examples described in more detail below, the dielectric can be racetrack shaped, having curved ends and flat surfaces extending between the curved ends. While the racetrack-shaped dielectric is closer to a rectangle than an oval-shaped dielectric, the flat surfaces of the dielectric can cause discontinuities in the electrical shield. For instance, signal transmission lines are often bent during use as they are routed from one data communication component to another data communication component. During bending, twisting, or other manipulation, the electrical shield can inadvertently deform, such as unwrap, kink, or otherwise loosen, which can degrade the performance of the signal transmission line. It is therefore desirable to provide a signal transmission line that reduces unwanted deformation of the electrical shield.
U.S. Pat. No. 2,761,137 is hereby incorporated by reference in its entirety.
“Square and Rectangular Waveguides with Rounded Corners”, Paul Lagasse and Jean Van Bladel, IEEE Transactions on Microwave Theory and Techniques, Vol. MTT-20, No. 5, May 1972, is hereby incorporated by reference in its entirety.
U.S. Pat. No. 5,363,464 is hereby incorporated by reference in its entirety.
United States Patent Publication No. 2008/0036558 is hereby incorporated by reference it its entirety.
U.S. Pat. No. 8,575,488 is hereby incorporated by reference in its entirety.
“Terahertz Dielectric Waveguides”, Shaghik Atakaramians, Shahraam Afshar V., Tanya M. Monro, and Derek Abbott, published Jul. 3, 2013 by Optica Publishing Group, formerly OSA in Advances in Optics and Photonics, Vol. 5, Issue 2, pp. 169-215, https://opg.optica.org/aop/fulltext.cfm?uri=aop-5-2-169&id=258388 (last accessed on 1 Apr. 2022) is hereby incorporated by reference in its entirety.
United States Patent Publication No. 2014/0368301 is hereby incorporated by reference in its entirety.
United States Patent Publication No. 2019/0173149 is hereby incorporated by reference in its entirety.
Patent Cooperation Treaty Publication No. WO2019/226987 is hereby incorporated by reference in its entirety.
United States Patent Publication No. 2021/0217542 is hereby incorporated by reference in its entirety.
United States Patent Publication No. 2018/0198184 is hereby incorporated by reference in its entirety.
Patent Cooperation Treaty Publication No. WO2020/232192 is hereby incorporated by reference in its entirety.

### SUMMARY

A technical problem to be solved is the unwanted or unintentional unwrapping of a first shield that surrounds a first dielectric material of the signal transmission line. For instance, in one example, a flexible signal transmission line can include a core that comprises a dielectric material, a first electrical shield that surrounds the core, an outer electrically insulative jacket, and a spacer disposed between the outer electrically insulative jacket and the electrical shield. The spacer can be configured to apply a compressive force to the electrical shield toward the core.

### BRIEF DESCRIPTION OF DRAWINGS

The foregoing summary, as well as the following detailed description of illustrative embodiments of the present application, will be better understood when read in conjunction with the appended drawings. It should be understood, however, that the application is not limited to the precise arrangements and instrumentalities shown. In the drawings:

FIG. 1A is a schematic perspective view of a signal transmission line;

FIG. 1B is cross-sectional view of the signal transmission line of FIG. 1A constructed as a dielectric waveguide in one example;

FIG. 1C is a cross-sectional view of a signal transmission line constructed as a dielectric waveguide in another example;

FIG. 1D is another cross-sectional view of the signal transmission line of FIG. 1C;

FIG. 1E is a cross-sectional view of a signal transmission line constructed as a dielectric waveguide in yet another example;

FIG. 1F is a cross-sectional view of a signal transmission line constructed as a substantially dielectric waveguide in one example;

FIG. 1G is a cross-sectional view of a signal transmission line constructed as a substantially dielectric waveguide in another example;

FIG. 2A is a cross-sectional view of a signal transmission line constructed as a semi-hollow waveguide in one example;

FIG. 2B is a cross-sectional view of a signal transmission line constructed as a semi-hollow waveguide in another example;

FIG. 2C is a cross-sectional view of a signal transmission line constructed as a hollow waveguide in one example;

FIG. 2D is a cross-sectional view of a signal transmission line constructed as a hollow waveguide in another example;

FIG. 3A is a cross-sectional view of a signal transmission line constructed as a coaxial electrical cable in one example;

FIG. 3B is a cross-sectional view of a signal transmission line constructed as a coaxial electrical cable in another example;

FIG. 3C is a cross-sectional view of a signal transmission line constructed as a coaxial electrical cable in still another example;

FIG. 3D is a cross-sectional view of a signal transmission line constructed as a twinaxial cable in one example; and

FIG. 3E is a cross-sectional view of a signal transmission line constructed as a twinaxial cable in another example.

### DETAILED DESCRIPTION

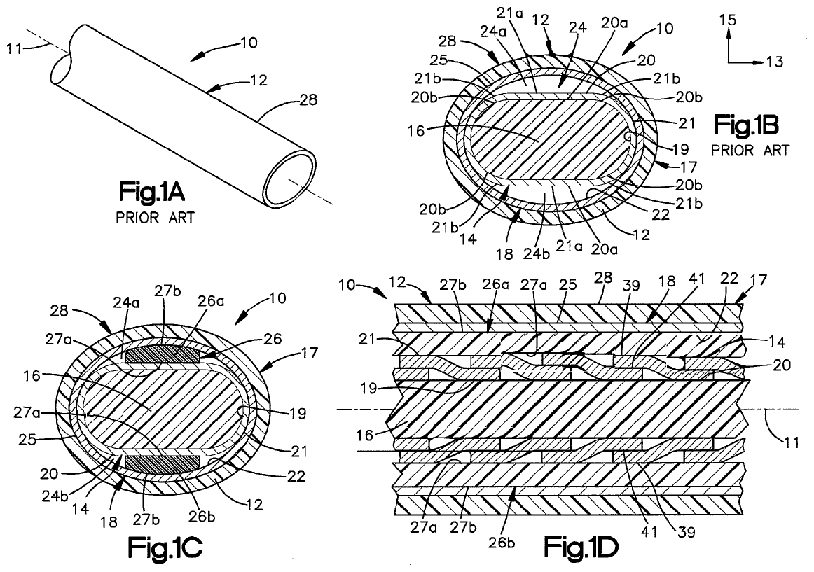

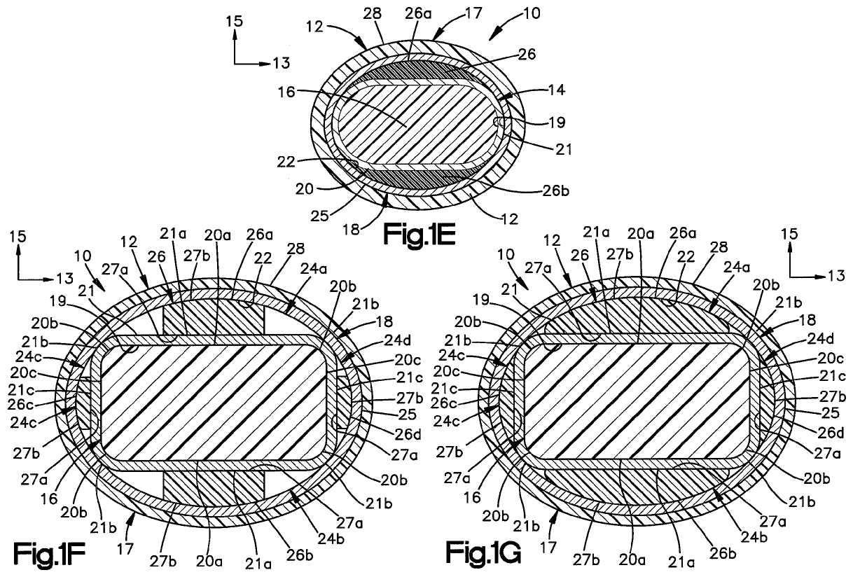

FIGS. 1A-3E show signal transmission lines constructed in accordance with different examples. Each signal transmission line can each be flexible, can each be a cable or can each be a flexible cable. Each signal transmission line can include one or more regions of dielectric material. Each dielectric material can be a solid dielectric material or a foamed dielectric material. Thus, each signal transmission line can include a solid dielectric, a formed dielectric, or both. As will be described in more detail below, the signal transmission line can be constructed as a waveguide, a coaxial electrical cable, or a twinaxial cable. The waveguide can be a dielectric waveguide, a hollow waveguide (without any internal supports), or a semi-hollow waveguide (with at least one internal support). Further, as will be described in more detail below, each signal transmission line can be flexible so as to be routed in any direction as desired. Thus, each signal transmission line can be a flexible coaxial signal transmission line with one or both of a solid and/or formed dielectric, a twinaxial signal transmission line with one or both of a solid/and or formed dielectric, a waveguide with a solid dielectric, a formed dielectric or both, a hollow waveguide with a solid dielectric, a formed dielectric or both, and/or a semi-hollow waveguide with a solid dielectric, a formed dielectric or both.

Referring now to FIGS. 1A-1B, a signal transmission line 10 can be elongate along a central axis 11. Further, the signal transmission line 10 can be bent so as to be routed in any direction as desired. Thus, the central axis 11 can be straight linear, curved, a combination of straight linear segments and curved segments, and can include as many bends as desired. A length of the signal transmission line 10 is defined along the central axis 11. The signal transmission line 10 can define a first direction 13 that is perpendicular to the central axis 11, and a second direction 15 that is perpendicular to each of the central axis 11 and the first direction 13. In one example, the first direction 13 can define a width of the signal transmission line 10, and the second direction 15 can define a height of the signal transmission line 10. The width of the signal transmission line 10 along the first direction 13 can be greater than the height of the signal transmission line 10 along the second direction 15. In other examples, the height of the signal transmission line 10 along the second direction 15 can be greater than the width of the signal transmission line 10 along the first direction 13. The signal transmission line 10 defines a radial direction that includes all directions perpendicular to the central axis 11. The radial direction can thus include either or both of the first and second directions 13 and 15, and combinations of the first and second directions 13 and 15. The term “radially” and derivatives thereof refer to the radial direction.

The signal transmission line 10 can be configured as a waveguide 12. Simulation modeling predicts that flexible waveguides described herein can satisfactorily operate in the V, E, W, F, D, G, WR-4.4 and WR-3.4 waveguide bands, essentially from approximately 50 to approximately 330 GHz. In one example, the waveguide 12 can include a core 16 through which data signals, including electrical signals, travel. The core 16 comprises a first dielectric material. In the context of a waveguide, the signals travel along the first dielectric material of the core 16. Thus, the waveguide 12 can be referred to as a dielectric waveguide 17. Further, the core 16 of the dielectric waveguide 17 can be defined by the first dielectric material. The core 16 can be elongate along the central axis 11. In the context of an electrical cable described below, the signals travel along one or more electrical conductors that, in turn, are disposed in the core 16.

The central axis 11 can extend through the core 16, and in particular through the first dielectric material of the core. In one example, the central axis 11 can be centrally disposed in the core 16. The first dielectric material of the core 16 can be any suitable dielectric or electrically insulative material as desired. The first dielectric material of the core 16 can be a non-compressible material or a compressible material as desired. In one example, the first dielectric material of the core 16 can be any suitable polymer such as a fluoropolymer. For instance, the first dielectric material can be polytetrafluoroethylene (PTFE). The first dielectric material, and thus the core 16, can define an outer core surface 20. In one example, the first dielectric material, whether solid or formed, is the only material disposed in the space defined by the outer surface 20. Otherwise stated, an entirety of the core 16 can be made of the first dielectric material. This in in contrast, for example, to a dielectric material that defines an inner surface boundary. Alternatively, the core 16 can comprise multiple dielectric layers that can define a single unitary structure, or can define discrete adjacent structures.

The outer core surface 20 can be oval-shaped, racetrack shaped, or otherwise oblong and/or substantially trapezoidal shaped (see FIGS. 1F-1G) as desired. In one example, the outer surface can define first and second regions, such as middle regions 20a, that are opposite each other along the second direction, and outer regions 20b that extend outward from the middle regions 20a along the first direction 13. When the outer core surface 20 is racetrack shaped, the middle regions 20a can be substantially flat and substantially straight and linear in cross-section, and can be substantially planar when the central axis 11 is substantially straight and linear. The middle regions 20a can extend along the first direction 13. The middle regions 20a can be opposite each other along the second direction 15, and can be on opposite sides of the central axis 11 with respect to the second direction 15. The middle regions 20a can be referred to as a pair of substantially flat and substantially straight and linear in cross-section, and thus substantially planar surfaces. The outer regions 20b can be curved inward toward, and in some examples to, a line or a plane that includes the central axis 11 and is perpendicular to the second direction 15. The middle regions 20a can define a substantially straight line in cross-section. Thus, the middle regions 20a can be substantially planar when the central axis 11 is substantially straight and linear. Respective outer regions 20b on each side of the central axis 11 can meet each other at a line or plane that includes the central axis 11 and is perpendicular to the second direction 15. In other examples, the middle regions 20a can be curved, for instance when the outer core surface 20 is oval-shaped.

The waveguide 12 can include a first or inner electrical shield 14 that surrounds and circumscribes the core 16. The first electrical shield 14 can abut the outer core surface 20. The first electrical shield 14 can be metal that can be wrapped or braided around the core 16, wound around the core 16, or otherwise disposed about the core 16. For instance, the first electrical shield 14 can be angled along the central axis 11 as it is wrapped about the core 16. In particular, the first electrical shield 14 can be wrapped, for instance helically wrapped, about the core 16. Alternatively, the first electrical shield 14 can be a longitudinal wrap, known as a cigarette wrap, that is concentrically wrapped about the core 16 without being angled along the central axis 11 as it is wrapped. The first electrical shield 14 can define overlapping regions whereby regions of the first electrical shield 14 overlap each other (see FIG. 1D). The overlapping regions can be helically shaped in a helical wrap, and can be oriented substantially along the central axis 11 when the shield is a longitudinal wrap. The electrically conductive material can be a metal. The first electrical shield 14 can be configured as an electrically conductive foil or any suitably alternatively constructed shield. The first shield 14 can be made from any suitable electrically conductive material, such as a metal or metal alloy, such as copper, silver, aluminum, or any combinations thereof. In one example, the first electrical shield 14 can be configured as a foil made only of copper. The first shield 14 can define an inner surface 19 that faces the outer core surface 20, and an outer surface 21 that is opposite the inner surface 19 and faces away from the core 16. The inner and outer surfaces 19 and 21 can be substantially parallel to each other.

The first electrical shield 14, including the inner surface 19 and the outer surface 21, can be oval-shaped, racetrack shaped, or otherwise oblong and/or substantially trapezoidal shaped (see FIGS. 1F-1G) as desired. In one example, the outer surface 21 define first and second middle regions 21a opposite each other along the second direction 15, and outer regions 21b that extend outward from opposed ends of the middle regions 21a along the first direction 13. When the outer surface 21 is racetrack shaped, the middle regions 21a can be substantially flat and substantially straight and linear in cross-section, and can be substantially planar when the central axis 11 is substantially straight and linear. Thus, the middle regions 21a can be substantially planar when the central axis 11 is substantially straight and linear. As the outer regions 21b extend away from the middle regions 21a in the first direction, the outer regions 21b can be curved inward toward, and in some examples to, a line or a plane that includes the central axis 11 and is perpendicular to the second direction 15. Respective outer regions 21b on each side of the central axis 11 can meet each other at a line or plane that includes the central axis 11 and is perpendicular to the second direction 15. In other examples, the middle regions 21a can be curved, for instance when the first electrical shield 14 is oval-shaped. When the first electrical shield 14 is disposed about the core 16, the middle regions 21a of the first electrical shield 14 extend along the respective middle regions 20a of the core 16, and the outer regions 21b of the first electrical shield extend along the respective outer regions 20b.

The waveguide 12 can include a second or outer electrical shield 18 that can surround, circumscribe, or at least partially circumscribe the first electrical shield 14, and thus the core 16. The first electrical shield 14 can thus be disposed between the core 16 and the second electrical shield 18. The second electrical shield 18 can be made from an electrically conductive material, such as a metal or metal alloy, such as copper, silver, aluminum, or any combinations thereof. The second electrical shield 18 can define an inner surface 22 that faces the first electrical shield 14, and an outer surface 25 that is opposite the inner surface 22. In one example, the second electrical shield 18 can define a wrap or a braid as desired. The second electrical shield 18 can define overlapping regions whereby regions of the second electrical shield 18 overlap each other. The second electrical shield 18 can be made from any suitable electrically conductive material, such as a metal or metal alloy, such as copper, silver, aluminum, or any combinations thereof. The second electrical shield 18 can thus be made from the same or a different material than the first electrical shield 14. The second electrical shield 18 can be curved along an entirety of its length. For instance, the inner surface 22 can be concave and the outer surface 25 can be convex. In one example, the second electrical shield 18 can be oval-shaped in cross section. The outer jacket 28 can similarly be oval shaped.

The signal transmission line 10 can further include a second or outer dielectric configured as an electrically insulative outer jacket 28 that surrounds the second electrical shield 18, and thus also surrounds the first electrical shield 14. In particular, the outer jacket 28 can be in continuous contact with the outer surface 25 of the second electrical shield 18 about an entirety or substantial entirety of the circumference of the outer surface 25. The outer jacket 28 can be defined by a second dielectric material, such as an electrically nonconductive polymer, a tape or other suitable electrically non-conductive material. A wound tape, for instance a helically wrapped tape, can provide compression and can reduce either or both of the width and the height of the signal transmission line 10. The outer jacket 28 can define the outermost surface of the signal transmission line 10.

The outer core surface 20 and the outer surface 21 of the first electrical shield 14 can each define, in cross-section, any one of an oval, a racetrack, or otherwise oblong and/or substantially trapezoidal shape (see FIGS. 1F-1G). In particular, the respective widths defined by the outer surfaces 20 and 21 along the first direction 13 is greater than the respective heights defined by the outer core surface 20 and 21 along the second direction 15. Ideally, the first electrical shield 14 can generally form the same or similar cross-sectional shape as the outer core surface 20, such that the inner surface 19 of the first electrical shield 14 physically touches and remains physically touching a substantial entirety of the outer core surface 20. A portion of the inner surface 22 of the second electrical shield 18 can physically touch, and can remain touching, the outer surface 21 of the first electrical shield during operation. Alternatively, an entirety of the second electrical shield 18 can be spaced from the first electrical shield 14.

During operation, the second shield 18 or the inner surface 22 of the second shield 18 does not necessarily completely or substantially touch all of the external contours or all of the outer surface 21 of the first electrical shield 14. For instance, the height of the inner surface 22 of the second electrical shield 18 along the second direction 15 can be greater than the height of the outer surface 21 of the first electrical shield 14 along the second direction 15. The width of the inner surface 22 of the second electrical shield 18 along the first direction 13 can be substantially equal to the width of the outer surface 21 of the first electrical shield 14 along the first direction 13. Therefore, the second electrical shield 18 can contact the first electrical shield 14 at opposed outermost first ends of the second electrical shield 18 that are opposite each other along the first direction 13 and aligned with the central axis 11 along the first direction 13, and can be spaced from the first electrical shield 14 at its opposed regions along the second direction 15. Otherwise stated, first and second regions of the second electrical shield 18 that are opposite each other along the second direction 15 can have a curvature greater than the respective first and second regions of the first electrical shield 14 and the core 16 that are opposite each other along the second direction 15. The first and second regions of the first electrical shield 14 can define the middle regions 21a of the outer surface 21. The first and second regions of the first electrical shield 14 can thus extend along the first and second middle regions 20a, respectively, of the outer core surface 20. The distance between the outer surface 21 of the first electrical shield 14 and the inner surface 22 of the second electrical shield 18 along the second direction 15 can be at its maximum at outermost second ends of the second electrical shield 18 that are opposite each other and aligned with the central axis 11 along the second direction 15. The distance between the outer surface 21 of the first electrical shield 14 and the inner surface 22 of the second electrical shield 18 along the second direction can decrease as the inner surface 22 of the second electrical shield 18 extends from the outermost second ends toward the outermost first ends. Further, because the inner surface 22 has a curvature in cross-section greater than that of the outer surface 21, the rate of decrease of the distance between the outer surface 21 and the inner surface 22 increases per unit linear measurement of the inner surface 22 along the first direction 13 as it extends from the second outermost locations to the first outermost locations

The signal transmission line 10 can define at least one void 24 that extends from the outer surface 21 of the first shield 14 to the inner surface 22 of the second shield 18 at locations whereby the outer surface 21 of the first shield 14 is spaced from the inner surface 22 of the second shield 18. The signal transmission line 10 can define first and second voids 24a and 24b. The first void 24a can be an upper void in the orientation shown in FIGS. 1B-1D disposed on one side of the central axis 11 with respect to the second direction 15, and the second void 24b can be a lower void in the orientation shown in FIGS. 1B-1D disposed on an opposite side of the central axis 11 with respect to the second direction 15. While the first void 24a is illustrated as an upper void in the orientation shown in FIGS. 1B-1D, and the second void 24b is illustrated as a lower void in the orientation shown in FIGS. 1B-1D, it is appreciated that the orientation of the signal transmission line 10 can vary during use. The first and second voids 24a-24b can contain air or any suitable gas as desired. The first and second voids 24a and 24b can be separated from each other by abutments of the outer surface 21 of the first electrical shield 14 and the inner surface 22 of the second electrical shield 18 at the outermost first ends of the second electrical shield 18. Alternatively, an entirety of the inner surface 22 of the second electrical shield 18 can be spaced from the outer surface 21 of the first electrical shield 14, and the first and second voids 24a and 24b can be open to each other.

As described above, the middle regions 20a of the outer surface of the core 16 and the middle regions 21a of the outer surface 21 of the first electrical shield 14 can be substantially flat, and can define a substantially straight line in cross-section. Thus, the middle regions 21a can be substantially planar when the central axis 11 is substantially straight and linear. Thus, the outer core surface 20 provides little or no retention force against the first electrical shield 14 at the middle regions 20a.

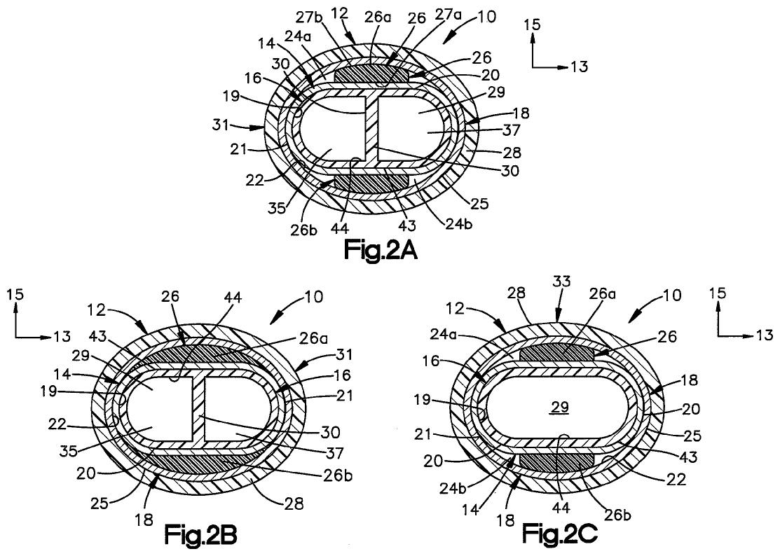

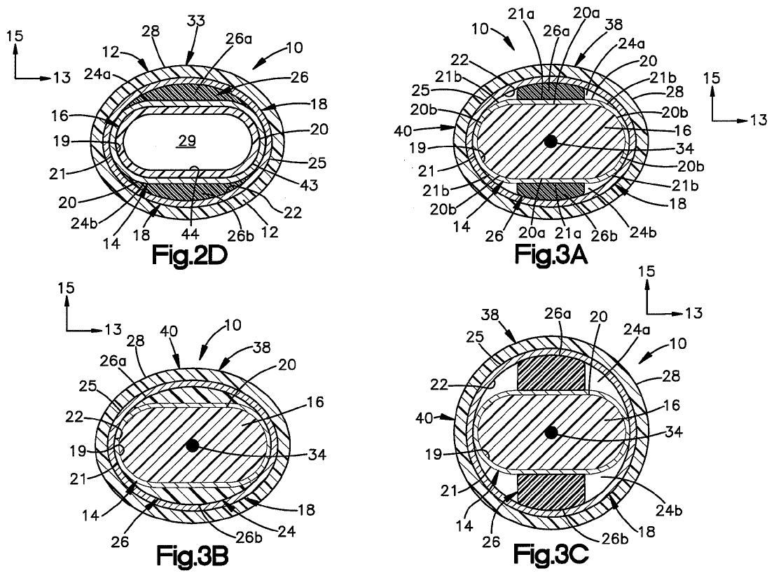

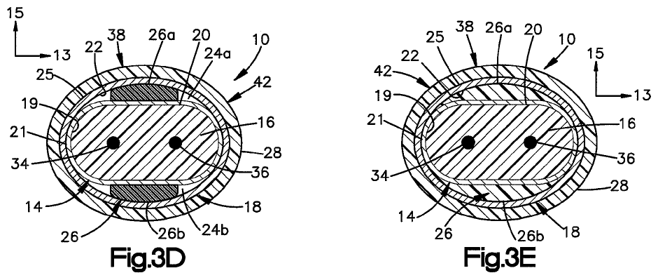

In particular, the present inventors have discovered when the first electrical shield 14 is disposed about the core, tension in the first electrical shield 14 can place the first electrical shield 14 under compression against the core 16 at regions whereby the first electrical shield 14 contact the outer regions 20b of the core 16, but can place the first electrical shield 14 under reduced or substantially no compression against the core 16 at regions whereby the first electrical shield extends along the middle regions 20a of the core 16. Thus, during operation, the first shield 14 or overlapping regions of the first electrical shield 14 can have a tendency to bunch or slip, for instance when the signal transmission line 10 is bent thereby bending the central axis 11, compressed along the second direction 15 or any direction that includes a directional component defined by the second direction 15, or twisted for instance about the central axis 11, thereby causing unwanted electrical discontinuities in the first electrical shield 14. The present inventors have discovered that unwanted electrical discontinuities can be caused because the first shield 14 is not under constant compression against the core 30 along an entirety of the length of the first shield 14. In some lower end applications, the signal transmission line 10 of FIG. 1B can still perform well enough electrically during operation of the signal transmission line 10. The signal transmission line 10 can be a waveguide 12 (see FIGS. 1A-2C), a coaxial cable (see FIGS. 3A-3C), or a twinaxial cable (see FIGS. 3D-3E).

However, for higher end applications, the signal transmission performance of the signal transmission line 10 can be improved. Referring now to FIGS. 1C-1D, the present inventors have solved the technical problem of the unwanted or unintentional unwrapping, kinking, loosening, etc. of the first shield 14, particularly as the signal transmission line 10 is bent, twisted, or otherwise manipulated. For example, the signal transmission line 10 can include at least one spacer 26 that is disposed in the at least one void 24, respectively. Stated another way, the at least one spacer 26 can be positioned between the outer surface 21 of the first shield 14 and the inner surface 22 of the second shield 18. The at least one spacer 26 can provide a respective compressive retention force to the first electrical shield 14 against the core 16.

The at least one spacer 26 can extend from the outer surface 21 of the first shield 14 to the inner surface 22 of the second shield 18. Thus, the at least one spacer 26 can directly abut the outer surface 21 of the first shield 14 and the inner surface 22 of the second shield 18. It can also be said that the at least one spacer 26 is positioned between the outer core surface 20 of the first shield 14 and the outer electrically insulative jacket 28. Further, the first shield 14 can be positioned between the core 16 and the at least one spacer 26. It can further be said that the second shield 18 is positioned between the at least one spacer 26 and the electrically insulative jacket 28. In alternative examples, the signal transmission line 10 can be devoid of the second shield 18, such that the at least one spacer 26 directly abuts the outer jacket 28. Alternatively, an intermediate structure can be disposed between the spacer 26 and the outer jacket 28. The outer jacket can circumferentially surround the intermediate structure. In still alternative examples, intermediate structure can be disposed between the outer surface 21 of the first shield 14 and the at least one spacer 26 and/or between the inner surface 22 of the second shield 18 and the at least one spacer 26.

The at least one spacer 26 can include a first spacer 26a disposed in the first void 24a, and a second spacer 26b disposed in the second void 24b. Thus, the first and second spacers 26a and 26b can be disposed on opposite sides of the central axis 11 with respect to the second direction 15. Each spacer 26 can bear against and thus provide a force against the inner electrical shield 14, and in particular the outer surface 21 of the inner electrical shield 14, and the outer electrical shield 18, and in particular the inner surface 22 of the outer electrical shield 18. For instance, the outer jacket 28 can apply a respective radial compressive force to the second electrical shield 18, which in turn urges each spacer 26 to apply a respective radial compressive force to the first electrical shield 14. Each spacer 26 can apply a force or a compression force or a constant force or a continuous force onto the first shield 14, for instance onto the outer surface 21 of the first shield. Each spacer 26 can compress the first shield 14 against the core 16. In some examples, the first and second spacers 26a and 26b can be mirror images of each other. Alternatively, the first and second spacers 26a and 26b can have respective sizes and/or shapes that are different from each other. The first and second spacers 26a and 26b can be aligned with each other and the central axis 11 along the second direction 15. The central axis 11 can be disposed between the first and second spacers 26a and 26b with respect to the second direction 15. Further, the first and second spacers 26a and 26b can be symmetrical in cross-section about a line that extends along the first direction 13 and intersects the central axis 11. Alternatively, the first and second spacers 26a and 26b can be asymmetric with respect to each other in cross-section about a line that extends along the first direction 13 and intersects the central axis 11.

Each spacer 26 can be defined by any suitable compliant material as desired. For instance, each spacer can be a solid material which can be an elastomer, a non-elastomer, or combination thereof. When each spacer 26 is an elastomer, each spacer 26 can be elastic both radially and axially along a direction defined by the central axis 11. In other examples, each spacer 26 can be a compliant fibrous material such as cotton. In other examples, each spacer 26 can be a solid rigid material such as metal. The metal can be sufficiently dimensioned to allow the spacer 26 to deform during use, for instance during bending and/or twisting of the signal transmission line 10. Alternatively, each spacer 26 can include a fluid, such as a liquid or gas, disposed in a solid casing. Alternatively still, each spacer 26 in the void 24 can be defined by a pressurized gas that is not confined in a solid casing. Each spacer 26 can be a discrete material or a non-discrete material as desired. It should further be appreciated that each spacer 26 can be mechanically compressible so as to deform locally in response to forces associated with manipulation of the signal transmission line 10. Alternatively, each spacer can be non-compressible as desired. In one example, each spacer 26 can be electrically nonconductive. In other examples, each spacer 26 can be electrically conductive. In still other examples, each spacer 26 can include both electrically conductive material and electrically nonconductive material. In other examples, each spacer 26 can be semi-conductive. In one specific example, the spacers 26 can be silicone.

Each spacer 26 can define a single monolithic structure that extends from the outer surface 21 of the first electrical shield 14 to the inner surface 22 of the second electrical shield 18. Each spacer 26 can define a middle region of each spacer 26 with respect to the first direction 13, and opposed end regions that extend from opposed ends of the middle region in opposite directions to respective outermost ends of each spacer 26 along the first direction 13. The end regions can be substantial mirror images of each other. Each spacer 26 can have a thickness along the second direction 15 at the middle region, and respective thickness of each of the end regions along the second direction 15. The thickness at the middle region can be greater than the thickness of each of the end regions along the second direction 15. In particular, the maximum thickness at the middle region is greater than the maximum thicknesses at each of the end regions.

With continuing reference to FIGS. 1C-1D, each spacer 26 can be a localized spacer that occupies a portion of the respective void 24 less than an entirety of the respective void 24. In particular, the end regions of each spacer 26 can terminate inward of the ends of the respective void 24 with respect to the first direction 13. One or more additional spacers can occupy the end regions of the respective voids 24 as desired. Each spacer 26 can define a first or inner surface 27a and a second or outer surface 27b opposite the first surface 27a. The first surface 27a can face the outer surface 21 of the first electrical shield 14, and the second surface 27b can face the inner surface 22 of the second electrical shield 18. Further, the first surface 27a can follow the contour of the outer surface 21 of the first electrical shield 14, and the second surface 27b can follow the contour of the inner surface 22 of the second electrical shield 18. Thus, the first surface 27a can be substantially flat, for instance when the outer core surface 20 is racetrack shaped. In other examples, for instance, when the outer core surface 20 is oval shaped, the first surface 27a can be concave. The second surface 27b can be curved, and in particular can be convex. Similarly, the inner surface 22 of the second electrical shield 18 can be concave along its entire length. In some examples, each spacer 26 can be adhered to the outer surface 21 of the first electrical shield 14, for instance using an adhesive.

As shown at FIGS. 1C-1D, each spacer 26 can be compressed against the outer surface 21 of the first shield 14 by the second shield 18, the outer jacket 28 or both. That is, each spacer 26 can bear directly against the metallic outer surface 21 of the first electrical shield 14. Each spacer 26 can further bear directly against the metallic inner surface 22 of the second electrical shield 18. Each spacer 26 can retain its original shape. Alternatively, as the signal transmission line 10 is bent, twisted, and or compressed along a direction perpendicular to the central axis 11, each spacer 26 can be compliant and can deform to extend into one or more locations of the void 24 previously unoccupied by the spacer 26 disposed in the void 24 as the signal transmission line 10 is bent, twisted, compressed, or otherwise manipulated. Each spacer 26 can be elastic both radially and axially along a direction defined by the central axis 11.

Each spacer 26 can apply a retention force to the first shield 14, and in particular to the outer surface 21 of the first shield 14, that urges or compress the first shield 14 against the underlying outer surface 20 of the core 16. In particular, each spacer 26 can apply a force the first shield that urges or compress the first shield 14 against the underlying outer surface 20 of the core 16. For instance, the outer jacket 28 can apply a compressive force to the second shield 18, which in turn applies the compressive force to each spacer 26, which compresses the first shield 14 against the core 16. The outer jacket 28 can apply the compressive force directly to the spacer 26 if the signal transmission line 10 does not include the second shield 18. In general, each spacer 26 can maintain a constant or at least a continuous force on the outer core surface 20 of the first shield 14 so as to prevent or reduce separation, kinking, twisting, slipping, or other unwanted loosening of the associated wrappings of the first shield 14 with respect to one another. In particular, the force from each spacer 26 can urge select wrappings 39 of the first shield 14 against adjacent wrappings 41 that are disposed inward of the select wrappings 39. In some examples, the adjacent wrappings 41 can be disposed between the select wrappings and the core 16. This reduction or prevention of unwanted loosening of the first electrical shield 14 helps to reduce or eliminate unwanted electrical discontinuities along a length of the signal transmission line 10. As a result, the present inventors have provided a racetrack-shaped waveguide that can have wider bandwidth than its oval-shaped counterpart, for instance from approximately 50 GHz to approximately 75 GHz, while avoiding discontinuities that can be produced in the first electrical shield when the core and shield are racetrack-shaped.

Each spacer 26 shown in FIG. 1C can occupy any percentage of the respective void 24 as desired. In one example, each spacer 26 can occupy greater than approximately 20 percent of the respective void 24 and less than approximately 80 percent of the respective void 24. For instance, each spacer 26 can occupy greater than approximately 30 percent of the respective void 24 and less than approximately 70 percent of the respective void 24. In one example, each spacer 26 can occupy greater than approximately 40 percent of the respective void 24 and less than approximately 60 percent of the respective void 24. Each spacer 26, and all spacers disclosed herein, can be defined by a material that allows for compliance when the signal transmission line 10 is bent and/or twisted. It is recognized that when the signal transmission line is bent, one side of the central axis 11 of the signal transmission line is placed in tension while the opposite side of the signal transmission line is paced in compression. Each spacer 26 can migrate within the respective void 24 during each of bending and twisting of the signal transmission line 10.

In particular, as the signal transmission line 10 is bent, twisted, compressed, or otherwise manipulated, the respective voids 24 can change shape. Further, each localized spacer 26 can be compliant and can thus be deformable. Therefore, when the spacer 26 occupies less than an entirety of the respective void 24, forces applied to the spacer 26 by the first electrical shield 14 and/or the second electrical shield 18 (or the outer jacket 28 if the signal transmission line 10 is devoid of the second electrical shield) during bending and/or twisting of the signal transmission line 10 can cause the spacer 26 to travel into one or more locations of the void 24 previously unoccupied by the spacer 26. As described above, the localized spacers 26 can be compressible. Further, the localized spacers 26 can be elastic. In particular, the localized spacers 26 can be elastic both axially along a direction defined by the central axis 11, and radially. Therefore, the compressibility allows the localized spacers 26 to deform locally in response to localized forces that are generated when the voids 24 change shape, for instance during bending and/or twisting of the signal transmission line. The elasticity of the filler spacers 26 can cause the localized spacers 26 to provide the retention force to the first electrical shield 14 in response to compression of the spacers 26 due to forces applied to the spacers during bending and/or twisting of the signal transmission line. In other examples, it should be appreciated that the localized spacers 26 can be non-compressible. Further, the localized spacers 26 can be inelastic and compliant, such that compressive forces applied to the spacer from the second electrical shield 18 (or from the outer jacket 28 if the signal transmission line does not include the second electrical shield) bias the spacer against the first electrical shield 14, which provides a retention force of the first electrical shield 14 against the core 16.

Referring now to FIG. 1E, the at least one spacer 26 can be configured as described above, with the exception that the at least one spacer 26 can be alternatively configured as desired so as to occupy any portion up to all of the respective void 24. For instance, the as illustrated, each spacer 26 can occupy a substantial entirety of the respective void 24. In other examples, each spacer 26 can occupy a substantial majority of the respective void 24, such as greater than approximately 80 percent of the void 24, for instance greater than 90 percent of the void, and in some examples greater than 95% of the void 24. Each spacer 26 can thus be referred to as a filler spacer. Further, the first and second filler spacers 26a and 26b can be symmetrical in cross-section about a line that extends along the first direction 13 and intersects the central axis 11. Alternatively, the first and second filler spacers 26a and 26b can be asymmetric with respect to each other in cross-section about a line that extends along the first direction 13 and intersects the central axis 11.

Each spacer 26 can be injection molded or over molded onto the outer surface 21 of the first shield 14, such as after the first shield 14 has been wrapped around, positioned on or carried by the core 16. In other examples, the core 16 can be extruded during a first extrusion step, and the first shield 14 can be formed abound the core 16 in the manner described above. Each spacer 26 can be extruded along the first shield 14 during a second extrusion step. While the filler spacer 26 can be a single monolithic structure as shown, it should be appreciated that the filer spacer 26 can alternatively be defined by a plurality of spacers 26 that combine to substantially fill the void 24.

As described above, each spacer 26 can apply a force to the first shield 14 that reduces or prevents instances of the first shield 14 unraveling or kinking or slipping when the signal transmission line 10 is bent, twisted, and/or compressed. Each spacer 26 can apply a force the first shield 14 that urges or compress the first shield 14 against the underlying outer surface 20 of the core 16. For instance, the outer jacket 28 can apply a compressive force to the second shield 18, which in turn applies the compressive force to each spacer 26, which compresses the first shield 14 against the core 16. The outer jacket 28 can apply the compressive force directly to the spacer 26 if the signal transmission line 10 does not include the second shield 18. In this example, and in flexible signal transmission lines with wrapped first shields 14 in particular, an electrically conductive adhesive or additive can be applied to the first shield 14 prior to injection or over molding of each spacer 26 to help seal openings between overlapped first shield 14 wrappings that might otherwise allow the spacer 26 to travel between overlapped wrappings of the first shield 14 during injection molding or over molding. In this embodiment, each spacer 26 can occupy an entirety, a substantial entirety, a majority, or any portion of the respective void 24 as desired. Further, as described above, the at least one spacer 26 can include first and second spacers 26a and 26b disposed in the respective first and second voids 24a and 24b.

As the signal transmission line 10 is bent, twisted, compressed, or otherwise manipulated, the respective voids 24 can change shape. Further, each spacer 26 can be compliant and can thus be deformable. Therefore, when the filler spacer 26 occupies less than an entirety of the respective void 24, forces applied to the spacer by the first electrical shield 14 and/or the second electrical shield 18 (or the outer jacket 28 if the signal transmission line 10 is devoid of the second electrical shield) during bending and/or twisting of the signal transmission line 10 can cause the spacer 26 to travel into one or more locations of the void 24 previously unoccupied by the spacer 26, as described above with respect to FIG. 1C. When the filler spacer 26 occupies a substantial entirety of the respective void 24, forces applied to the spacer by the first electrical shield 14 and/or the second electrical shield 18 (or the outer jacket 28 if the signal transmission line 10 is devoid of the second electrical shield) during bending and/or twisting of the signal transmission line 10 can cause the spacers 26 to deform as the voids 24 change shape such that the spacers 26 continue to occupy a substantial entirety of the voids 24 during bending and/or twisting of the signal transmission line 10. For instance, the outer surface 21 of the first electrical shield 14 and the inner surface 22 of the second electrical shield 18 (or inner surface of the outer jacket 28 if there is no second electrical shield 18) can apply a force to the spacers 26 as the voids 24 change shape so that the spacers 26 continue to substantially fill the voids 24. As described above, the filler spacers 26 can be elastic and compressible. In particular, the filler spacers 26 can be elastic both axially along a direction defined by the central axis 11, and radially. Therefore, the compressibility allows the filler spacers 26 to deform locally in response to localized forces that are generated when the voids 24 change shape, for instance during bending and/or twisting of the signal transmission line. The elasticity of the filler spacers 26 can cause the filler spacers 26 to provide the retention force to the first electrical shield 14. In other examples, it should be appreciated that the filler spacers 26 can be non-compressible. Further, the filler spacers 26 can be inelastic and compliant, such that compressive forces applied to the spacer from the second electrical shield 18 (or from the outer jacket 28 if the signal transmission line does not include the second electrical shield) bias the spacer against the first electrical shield 14, which provides a retention force of the first electrical shield 14 against the core 16.

As used herein, unless indicated otherwise, the term substantially,” “approximately,” and derivatives thereof, and words of similar import, when used to described sizes, shapes, spatial relationships, distances, directions, and other similar parameters includes the stated parameter in addition to a range up to 10% more and up to 10% less than the stated parameter, including up to 5% more and up to 5% less, including up to 3% more and up to 3% less, including up to 1% more and up to 1% less. Further, it should be appreciated that any of the components of all signal transmission lines 10 described herein, including the core 16, the first electrical shield 14, the at least one spacer 26, the second electrical shield 18, and the outer jacket 28, can be configured as described above with respect to FIGS. 1A-1G unless otherwise indicated.

Referring now to FIGS. 1F-1G generally, the present inventors have discovered that the dielectric waveguide 17, and thus the signal transmission line 10, can further approximate a rectangle with respect to the racetrack-shaped core 16 and first electrical shield 14 of FIGS. 1B-1E. In particular, the core 16 and the first electrical shield 14 of the signal transmission line 10, and in particular of the waveguide 12, of FIGS. 1F-1G can be substantially trapezoidal in cross-section. For instance, the core 16 and the first electrical shield 14 can be substantially rectangular in cross-section, and thus can include two pairs of opposed flat and substantially straight and linear surfaces in cross-section. The signal transmission line 10 can include a plurality of spacers 26 that provide compressive retention forces to the first electrical shield 14 against the core 16. The spacers 26 can be disposed between the substantially straight and linear surfaces of the first electrical shield 14 and the second electrical shield 18. The retention force can maintain contact between the first electrical shield 14 and the core 16 during bending of the signal transmission line 10, twisting of the signal transmission line 10 about the central axis 11, and compression of the signal transmission line 10 along any direction perpendicular to the central axis 11. The waveguides 12 of FIGS. 1F-1G will now be described in more detail.

In particular, the outer core surface 20 defines first and second regions, which can be defined by the middle regions 20a, that are opposite each other along the second direction 15 in the manner described above. The outer core surface 20 can further third and fourth regions, such as middle regions 20c, that are opposite each other along the first direction 13. The middle regions 20c can be substantially flat and substantially planar in cross-section. For instance, the middle regions 20c can extend along the second direction 15 while the middle regions 20a can extend along the first direction 13. The middle regions 20a can be referred to as a first pair middle regions 20a of the outer core surface 20. The middle regions 20c can be referred to as a second pair of middle regions 20c of the outer core surface 20. The middle regions 20a can be opposite each other along the second direction 15, and can be on opposite sides of the central axis 11 with respect to the second direction 15. The middle regions 20c can be opposite each other along the first direction 13, and can be on opposite sides of the central axis with respect to the first direction 13. Each of the middle regions 20a can extend between the middle regions 20c, and each of the middle regions 20c can extend between the middle regions 20a. The outer regions 20b can adjoin respective adjacent ones of the middle regions 20a and the middle regions 20c. The outer regions 20b can be convex, and can define rounded corners. Thus, the middle regions 20a, the middle regions 20c, and the outer regions 20b can combine to define a substantial rectangle with rounded corners. The substantial rectangular shape of the outer core surface 20, and thus of the core 16, can be elongate along the first direction 13. Thus, the middle regions 20a can be longer than the middle regions 20c. Alternatively, the outer core surface 20, and core 16, can be a substantial square whereby the lengths of the middle regions 20a are substantially equal to the lengths of the middle regions 20c.

The first or inner electrical shield 14 that surrounds and circumscribes the core 16. The first electrical shield 14 can abut the outer core surface 20. As described above, the first electrical shield 14 can be metal that can be wrapped or braided around the core 16, wound around the core 16, or otherwise disposed about the core 16. The first electrical shield 14 can be configured as an electrically conductive foil or any suitable alternatively constructed shield. The first shield 14 can be made from any suitable electrically conductive material, such as a metal or metal alloy, such as copper, silver, aluminum, or any combinations thereof.

The first electrical shield 14, including the inner surface 19 and the outer surface 21, can be substantially rectangular in cross-section. As described above, the outer surface 21 can define first and second middle regions 21a opposite each other along the second direction 15. The middle regions 21a can be substantially flat and substantially straight linear in cross-section, and can be substantially planar when the central axis 11 is substantially straight and linear. The outer surface 21 can further third and fourth regions, such as middle regions 21c, that are opposite each other along the first direction 13. The middle regions 21c can be substantially flat and substantially straight and linear in cross-section, and can be substantially planar when the central axis 11 is substantially straight and linear. For instance, the middle regions 21c can extend along the second direction 15 while the middle regions 21a can extend along the first direction 13. The middle regions 21a can be referred to as a first pair middle regions 21a of the outer surface 21. The middle regions 21c can be referred to as a second pair of middle regions 21c of the outer surface 21. The middle regions 21a can be opposite each other along the second direction 15, and can be on opposite sides of the central axis 11 with respect to the second direction 15. The middle regions 21c can be opposite each other along the first direction 13, and can be on opposite sides of the central axis with respect to the first direction 13. Each of the middle regions 21a can extend between the middle regions 21c, and each of the middle regions 21c can extend between the middle regions 21a. The outer regions 21b can adjoin respective adjacent ones of the middle regions 21a and the middle regions 21c. The outer regions 21b can be convex, and can define rounded corners. Thus, the middle regions 21a, the middle regions 21c, and the outer regions 21b can combine to define a substantial rectangle with rounded corners. The substantial rectangular shape of the outer surface 21, and thus of the first electrical shield 14, can be elongate along the first direction 13. Thus, the middle regions 21a can be longer than the middle regions 21c. Alternatively, the outer surface 21, and first shield 14, can be a substantial square whereby the lengths of the middle regions 21a are substantially equal to the lengths of the middle regions 21c.

The signal transmission lines 10 of FIGS. 1F-1G can include the second electrical shield 18 and the outer jacket 28. The second electrical shield 18 can be curved along an entirety of its length, and can contact the first electrical shield 21 at the outer regions 21b, and spaced from each of the middle regions 21a and 21c. Thus, the signal transmission line 10 defines a plurality of voids disposed between the outer surface 21 of the first electrical shield 14 and the inner surface 22 of the second electrical shield 18. In particular, opposed first and second voids 24a and 24b can be defined between the inner surface 22 of the second electrical shield 18 and the middle regions 21a, respectively, of the first electrical shield 14. The first and second voids 24a and 24b can be opposite each other along the second direction 15, and can be referred to as a first pair of voids. Opposed third and fourth voids 24c and 24d can be defined between the inner surface 22 of the second electrical shield 18 and the middle regions 21c, respectively, of the first electrical shield 14. The third and fourth voids 24c and 24d can be opposite each other along the first direction 13, and can be referred to as a second pair of voids. The voids 24a-24d can further be defined by abutments between the inner surface 22 of the second electrical shield 18 and the outer surface 21 of the first electrical shield 14. Alternatively, the second electrical shield 18 can be spaced from an entirety of the first electrical shield 21, such that adjacent ones of the voids 24a-24d are open to each other.

When the first electrical shield 14 is disposed about the core 16, the present inventors have discovered that tension in the first electrical shield 14 places the first electrical shield 14 under compression against the core 16 at regions whereby the first electrical shield 14 contact the outer regions 20b of the core 16, but can place the first electrical shield under reduced or substantially no compression against the core 16 at regions whereby the first electrical shield 14 extends along the flat middle regions 20a of the core 16. Thus, during operation, the first shield 14 or overlapping regions of the first electrical shield 14 can have a tendency to bunch or slip, for instance when the signal transmission line 10 is bent thereby bending the central axis 11, compressed along a direction perpendicular to the central axis 11, or twisted for instance about the central axis 11, thereby causing unwanted electrical discontinuities in the first electrical shield 14. The present inventors have discovered that unwanted electrical discontinuities can be caused because the first shield 14 is not under constant compression against the core 30 along an entirety of the length of the first shield 14.

With continuing reference to FIGS. 1F-1G, the signal transmission line 10 can include at least one spacer 26 that is disposed in the at least one void 24, respectively. Stated another way, each spacer 26 can be positioned between the outer surface 21 of the first shield 14 and the inner surface 22 of the second shield 18. Each spacer 26 can extend from the outer surface 21 of the first shield 14 to the inner surface 22 of the second shield 18. Thus, the at least one spacer 26 can directly abut the outer surface 21 of the first shield 14 and the inner surface 22 of the second shield 18. It can also be said that each spacer 26 is positioned between the outer core surface 20 of the first shield 14 and the outer electrically insulative jacket 28. Further, the first shield 14 can be positioned between the core 16 and each spacer 26. It can further be said that the second shield 18 is positioned between each spacer 26 and the electrically insulative jacket 28. In alternative examples, the signal transmission line 10 can be devoid of the second shield 18, such that each spacer 26 directly abuts the outer jacket 28. In still alternative examples, intermediate structure can be disposed between the outer surface 21 of the first shield 14 and each spacer 26 and/or between the inner surface 22 of the second shield 18 and each spacer 26.

The at least one spacer 26 can include a first spacer 26a disposed in the first void 24a, a second spacer 26b disposed in the second void 24b, a third spacer 26c disposed in the third void 24c, and a fourth spacer 26d disposed in the fourth void 24d. Thus, the first and second spacers 26a and 26b can be disposed on opposite sides of the central axis 11 with respect to the second direction 15. The third and fourth spacers 26c and 26d can be disposed on opposite sides of the central axis with respect to the third direction 13. Each spacer 26 can bear against and thus provide a force against the inner electrical shield 14, and in particular the outer surface 21 of the inner electrical shield 14, and the outer electrical shield 18, and in particular the inner surface 22 of the outer electrical shield 18. For instance, the outer jacket 28 can apply a respective radial compressive force to the second electrical shield 18, which in turn urges each spacer 26 to apply a respective radial compressive force to the first electrical shield 14. Each spacer 26 can apply a force or a compression force or a constant force or a continuous force onto the first shield 14, for instance onto the outer surface 21 of the first shield. Each spacer 26 can compress the first shield 14 against the core 16. Thus, the first spacer 26a can compress the first region 21a of the first shield 14 against the first region 20a of the core 16. The second spacer 26b can compress the second region 21a of the first shield 14 against the second region 20a of the core 16. The third spacer 26c can compress the third region 21c of the first shield 14 against the third region 20c of the core 16. The fourth spacer 26d can compress the fourth region 21c of the first shield 14 against the fourth region 20c of the core 16. In some examples, the first and second spacers 26a and 26b can be mirror images of each other, and the third and fourth spacers 26c and 26d can be mirror images of each other. Alternatively, the spacers 26a-26d can have respective sizes and/or shapes that are different from each other. The first and second spacers 26a and 26b can be aligned with each other and the central axis 11 along the second direction 15, and the third and fourth spacers 26c and 26d can be aligned with each other and the central axis 11 along the first direction 12.

Each spacer 26 can be defined by any suitable material such as a solid material, a discrete material, a discrete solid material, an elastomeric material, a discrete elastomeric material, or any combination thereof can be positioned in the respective void 24. In one example, each spacer 26 can be electrically nonconductive. In other examples, each spacer 26 can be electrically conductive. In still other examples, each spacer 26 can include both electrically conductive material and electrically nonconductive material. Each spacer 26 can be mechanically non-compressible or mechanically compressible during normal use of the signal transmission line 10, for instance when the signal transmission line 10 is bent. Each spacer 26 can define a single monolithic structure that extends from the outer surface 21 of the first electrical shield 14 to the inner surface 22 of the second electrical shield 18. Each spacer 26 can define a middle region of each spacer 26 with respect to the first direction 13, and opposed end regions that extend from opposed ends of the middle region in opposite directions to respective outermost ends of each spacer 26 along the first direction 13. The end regions can be substantial mirror images of each other. Each spacer 26 can have a maximum thickness that is measured from the outer core surface 20 to the second shield 18. Each spacer can have a maximum thickness at its geometric center, which can be a centerline or a central region, and the thickness can decrease as each spacer extends out from the geometric center.

Referring now to FIG. 1F in particular, each of the spacers 26a-26d can be configured as localized spacers that occupy a portion of the respective void 24 less than an entirety of the respective void 24. In particular, the end regions of each spacer 26 can terminate inward of the ends of the respective void 24 with respect to the first direction 13. One or more additional spacers can occupy the end regions of the respective voids 24 as desired. Each spacer 26 can define a first or inner surface 27a and a second or outer surface 27b opposite the first surface 27a. The first surface 27a can face the outer surface 21 of the first electrical shield 14, and the second surface 27b can face the inner surface 22 of the second electrical shield 18. Further, the first surface 27a can follow the contour of the outer surface 21 of the first electrical shield 14, and the second surface 27b can follow the contour of the inner surface 22 of the second electrical shield 18. Thus, the first surface 27a can be substantially flat, for instance when the outer core surface 20 is racetrack shaped. In other examples, for instance, when the outer core surface 20 is oval shaped, the first surface 27a can be concave. The second surface 27b can be curved, and in particular can be convex. Similarly, the inner surface 22 of the second electrical shield 18 can be concave along its entire length. In some examples, each spacer 26 can be adhered to the outer surface 21 of the first electrical shield 14, for instance using an adhesive.

The first and second localized spacers 26a and 26b can be symmetrical in cross-section about a line that extends along the first direction 13 and intersects the central axis 11. Alternatively, the first and second localized spacers 26a and 26b can be asymmetric with respect to each other in cross-section about a line that extends along the first direction 13 and intersects the central axis 11. Similarly, the third and fourth localized spacers 26c and 26d can be symmetrical in cross-section about a line that extends along the second direction 15 and intersects the central axis 11. Alternatively, the third and fourth localized spacers 26c and 26d can be asymmetric with respect to each other in cross-section about a line that extends along the second direction 15 and intersects the central axis 11.

As described above, each spacer 26 can be compressed against the outer surface 21 of the first shield 14 by the second shield 18, the outer jacket 28 or both. That is, each spacer 26 can bear directly against the metallic outer surface 21 of the first electrical shield 14. Each spacer 26 can further bear directly against the metallic inner surface 22 of the second electrical shield 18. Each spacer 26 can retain its original shape. Each spacer 26 can apply a force the first shield that urges or compress the first shield 14 against the underlying outer surface 20 of the core 16. For instance, the outer jacket 28 can apply a compressive force to the second shield 18, which in turn applies the compressive force to each spacer 26, which compresses the first shield 14 against the core 16. The outer jacket 28 can apply the compressive force directly to the spacer 26 if the signal transmission line 10 does not include the second shield 18. In general, each spacer 26 can maintain a constant or at least a continuous force on the outer core surface 20 of the first shield 14 so as to prevent or reduce separation, kinking, twisting, slipping, or other unwanted loosening of the associated wrappings of the first shield 14 with respect to one another. In particular, the force from each spacer 26 can urge select wrappings 39 of the first shield 14 against adjacent wrappings 41 that are disposed inward of the select wrappings 39. In some examples, the adjacent wrappings 41 can be disposed between the select wrappings and the core 16. This reduction or prevention of unwanted loosening of the first electrical shield 14 helps to eliminate unwanted electrical discontinuities along a length of the signal transmission line 10.

During operation, as the signal transmission line 10 is bent, twisted, compressed, or otherwise manipulated, the respective voids 24 can change shape. Further, each localized spacer 26 can be compliant and can thus be deformable. Therefore, when the spacer 26 occupies less than an entirety of the respective void 24, forces applied to the spacer 26 by the first electrical shield 14 and/or the second electrical shield 18 (or the outer jacket 28 if the signal transmission line 10 is devoid of the second electrical shield) during bending and/or twisting of the signal transmission line 10 can cause the spacer 26 to travel into one or more locations of the void 24 previously unoccupied by the spacer 26. As described above, the localized spacers 26 can be elastic and compressible. In particular, the localized spacers 26 can be elastic both axially along a direction defined by the central axis 11, and radially. Therefore, the compressibility allows the localized spacers 26 to deform locally in response to localized forces that are generated when the voids 24 change shape, for instance during bending and/or twisting of the signal transmission line. The elasticity of the filler spacers 26 can cause the localized spacers 26 to provide the retention force to the first electrical shield 14. In other examples, it should be appreciated that the localized spacers 26 can be non-compressible. Further, the localized spacers 26 can be inelastic and compliant, such that compressive forces applied to the spacer from the second electrical shield 18 (or from the outer jacket 28 if the signal transmission line does not include the second electrical shield) bias the spacer against the first electrical shield 14, which provides a retention force of the first electrical shield 14 against the core 16.

Referring now to FIG. 1G the spacers 26a-26d can alternatively be configured as filler spacers described above with respect to FIG. 1E. Thus, the spacers 26a-26d can be configured as desired so as to occupy any portion up to all of the respective void 24. For instance, as illustrated, each spacer 26 can occupy a substantial entirety of the respective void 24. In other examples, each spacer 26 can occupy a substantial majority of the respective void 24, such as greater than approximately 80 percent of the void 24, for instance greater than 90 percent of the void, and in some examples greater than 95% of the void 24. The spacers 26a-26d can thus be referred to as filler spacers. Each spacer 26 can be injection molded or over molded onto the outer surface 21 of the first shield 14, such as after the first shield 14 has been wrapped around, positioned on or carried by the core 16. In other examples, the core 16 can be extruded during a first extrusion step, and the first shield 14 can be formed abound the core 16 in the manner described above. Each spacer 26 can be extruded along the first shield 14 during a second extrusion step. While the filler spacer 26 can be a single monolithic structure as shown, it should be appreciated that the filer spacer 26 can alternatively be defined by a plurality of spacers 26 that combine to substantially fill the void 24.

The first and second filler spacers 26a and 26b can be symmetrical in cross-section about a line that extends along the first direction 13 and intersects the central axis 11. Alternatively, the first and second filler spacers 26a and 26b can be asymmetric with respect to each other in cross-section about a line that extends along the first direction 13 and intersects the central axis 11. Similarly, the third and fourth filler spacers 26c and 26d can be symmetrical in cross-section about a line that extends along the second direction 15 and intersects the central axis 11. Alternatively, the third and fourth filler spacers 26c and 26d can be asymmetric with respect to each other in cross-section about a line that extends along the second direction 15 and intersects the central axis 11.

As described above, each spacer 26 can apply a force to the first shield 14 that reduces or prevents instances of the first shield 14 unraveling or kinking or slipping when the signal transmission line 10 is bent, twisted, and/or compressed. In particular, each spacer 26 can apply a force the first shield that urges or compress the first shield 14 against the underlying outer surface 20 of the core 16. For instance, the outer jacket 28 can apply a compressive force to the second shield 18, which in turn applies the compressive force to each spacer 26, which compresses the first shield 14 against the core 16. The outer jacket 28 can apply the compressive force directly to the spacer 26 if the signal transmission line 10 does not include the second shield 18. In this example, and in flexible signal transmission lines with wrapped first shields 14 in particular, an electrically conductive adhesive or additive can be applied to the first shield 14 prior to injection or over molding of the spacers 26a-26d to help seal openings between overlapped first shield 14 wrappings that might otherwise allow the spacer 26 to travel between overlapped wrappings of the first shield 14 during injection molding or over molding.

As the signal transmission line 10 is bent, twisted, compressed, or otherwise manipulated, the respective voids 24 can change shape. Further, each spacer 26 can be compliant and can thus be deformable. Therefore, when the filler spacer 26 occupies less than an entirety of the respective void 24, forces applied to the spacer by the first electrical shield 14 and/or the second electrical shield 18 (or the outer jacket 28 if the signal transmission line 10 is devoid of the second electrical shield) during bending and/or twisting of the signal transmission line 10 can cause the spacer 26 to travel into one or more locations of the void 24 previously unoccupied by the spacer 26, as described above with respect to FIG. 1F. When the filler spacer 26 occupies a substantial entirety of the respective void 24, forces applied to the spacer by the first electrical shield 14 and/or the second electrical shield 18 (or the outer jacket 28 if the signal transmission line 10 is devoid of the second electrical shield) during bending and/or twisting of the signal transmission line 10 can cause the spacers 26 to deform as the voids 24 change shape such that the spacers 26 continue to occupy a substantial entirety of the voids 24 during bending and/or twisting of the signal transmission line 10. For instance, the outer surface 21 of the first electrical shield 14 and the inner surface 22 of the second electrical shield 18 (or inner surface of the outer jacket 28 if there is no second electrical shield 18) can apply a force to the spacers 26 as the voids 24 change shape so that the spacers 26 continue to substantially fill the voids 24. As described above, the filler spacers 26 can be elastic and compressible. In particular, the filler spacers 26 can be elastic both axially along a direction defined by the central axis 11, and radially. Therefore, the compressibility allows the filler spacers 26 to deform locally in response to localized forces that are generated when the voids 24 change shape, for instance during bending and/or twisting of the signal transmission line. The elasticity of the filler spacers 26 can cause the filler spacers 26 to provide the retention force to the first electrical shield 14. In other examples, it should be appreciated that the filler spacers 26 can be non-compressible. Further, the filler spacers 26 can be inelastic and compliant, such that compressive forces applied to the spacer from the second electrical shield 18 (or from the outer jacket 28 if the signal transmission line does not include the second electrical shield) bias the spacer against the first electrical shield 14, which provides a retention force of the first electrical shield 14 against the core 16.

Referring now to FIGS. 2A-2D generally, the waveguide 12 of the signal transmission line 10 can be configured as a semi-hollow waveguide 31 as shown in FIGS. 2A-2B, whereby the core 16 is semi-hollow. In other examples, the waveguide 12 can be a hollow waveguide 33 as shown in FIG. 2C-2D, whereby the core is hollow. Referring now to FIG. 2A, it should be appreciated that while the core 16 of the signal transmission line 10 shown in FIGS. 1B-1E includes a solid or formed dielectric material as described above, it should be appreciated that the core 16 can be alternatively constructed. In particular, the core can include an outer wall 43 that defines the outer core surface 20 and an inner surface 44 opposite the outer core surface 20. The outer wall 43 can be defined by the first dielectric material described above. The outer wall 43 of the core 16, and in particular the inner surface 44, can define at least one channel 29 that can be devoid of the first dielectric material. Instead, the at least one channel 29 can be hollow, and can contain any suitable gas such as air. Thus, it should be appreciated that the core 16 of the semi-hollow waveguide 31 can include both the first dielectric material and the gas.

The core 16 can further include at least one internal support wall 30 that divides the channel 29 into a first hollow channel 35 and a second hollow channel 37. In this regard, the internal support wall 30 can also be referred to as a divider wall that divides a channel into two channels. In one example, the internal support wall 30 can extend in the channel 29 along the second direction 15 from a first middle region of the core 16 to a second middle region of the core 16, wherein the first and second middle regions of the first electrical shield 14 define the first and second middle regions 20a of the outer core surface 20. The support wall 30 can be made from the same first dielectric material as the outer wall 43. In one example, the support wall 30 can be monolithic with the outer wall 43. In other examples, the support wall 30 can be separate from and discretely secured to the outer wall 43, and can be made from any suitable material as desired, including an electrically insulative material. In some examples, the internal support wall 30 can bifurcate the channel 29. For instance, the support wall 30 can be centrally disposed in the channel 29. Thus, the central axis 11 can extend through the support wall 30. The support wall 30 can divide the channel 29 into a first hollow channel 35 and a second hollow channel 37 that is adjacent the first hollow channel 35 along the first direction 13, and separated from the first hollow channel 35 by the support wall 30. The first and second hollow channels 35 and 37 can be mirror images of each other, and thus sized and shaped the same as each other. Any suitable gas, such as air, can be disposed in each of the first and second hollow channels 35 and 37. Further, the gas can be the only material disposed in the first and second hollow channels 35 and 37 in some examples. Otherwise said, the first and second hollow channels 35 and 37 can be devoid of solid dielectric material.

Because the waveguide 12 includes the internal support wall 30 that divides the channel 29 into more than one hollow channel, the waveguide 12 can be referred to as a semi-hollow waveguide. The internal support wall 30 can provide mechanical structure and rigidity to the core 16 and the signal transmission line 10, which can define a flexible waveguide 12. While the semi-hollow waveguide 31, and in particular the core 16, is shown having a single internal support wall 30, it should be appreciated that the semi-hollow waveguide 12 can have any suitable number of internal support walls 30 as desired that extend from the first middle region to the second middle region 21a and divide the channel 29 into a plurality of hollow channels 35 and 37.

As shown in FIG. 2A, each spacer 26 of the semi-hollow waveguide 31 can be a localized spacer configured as described above with respect to FIG. 1C, and can be configured to urge or compress the first electrical shield against the outer core surface 20. The outer core surface 20 can be defined by the outer wall 43 of the core 16 as described above. Alternatively, as shown in FIG. 2B, each spacer 26 of the semi-hollow waveguide 31 can be a filler spacer configured as described above with respect to FIG. 1E of the dielectric waveguide 17.

Referring now to FIGS. 2C, the waveguide 12 of the signal transmission line can define the hollow waveguide 33. In particular, while the core 16 of the signal transmission line 10 shown in FIGS. 1B-1E includes only the first dielectric material described above, it should be appreciated that the core 16 of the hollow waveguide 33 can be devoid of solid dielectric material inside the outer wall 43, and instead can define a single hollow channel 29 that contains only gas such as air. Thus, the core 16 of the hollow waveguide 33 can include the first dielectric material that defines the outer wall 43, and only air in the hollow channel 29 that is defined by the inner surface 44 of the outer wall 43. The hollow waveguide 33 is distinguished from the semi-hollow waveguide 31 of FIGS. 2A-2B in that the hollow waveguide 33 is devoid of any support walls such as support walls 30 (see FIGS. 2A-2B) that extends through the hollow channel 29. Thus, the hollow channel 29 is a single channel defined by the inner surface 44 of the core 16. Otherwise stated, the hollow channel 29 defined by the outer wall 43 of the core 16 is devoid of any material other than gas, such as air. The hollow channel 29 therefore is also devoid of solid dielectric material. The resulting waveguide can be referred to as the hollow waveguide 33.

As shown in FIG. 2C, each spacer 26 of the hollow waveguide 33 can be configured as a localized spacer described above with respect to FIG. 1C, and can be configured to urge or compress the first electrical shield 14 against the outer core surface 20. The outer core surface 20 can be defined by the outer wall 43 of the core 16 as described above. Alternatively, as shown in FIG. 2D, each spacer 26 of the hollow waveguide 33 can be configured as a filler spacer as described above with respect to FIG. 1E of the dielectric waveguide 17. Further, it should be appreciated that the substantially rectangular dielectric waveguide 17 of FIG. 1F can be configured as a semi-hollow waveguide as described above with respect to FIG. 2A, whereby the core 16 is a semi-hollow core. Alternatively, the substantially rectangular dielectric waveguide 17 of FIG. 1F can be configured as a hollow waveguide as described above with respect to FIG. 2C. Further still, it should be appreciated that the substantially rectangular dielectric waveguide 17 of FIG. 1G can be configured as a semi-hollow waveguide as described above with respect to FIG. 2B, whereby the core 16 is a semi-hollow core. Alternatively, the substantially rectangular dielectric waveguide 17 of FIG. 1F can be configured as a hollow waveguide as described above with respect to FIG. 2D.

Referring now to FIGS. 3A-3E in general, the signal transmission line 10 can be configured as an electrical cable 38. The electrical cable 38 can be configured as a coaxial cable 40 as shown in FIG. 3A-3C, or a twinaxial cable 42 shown in FIG. 3D-3E.

Referring now to FIG. 3A, the signal transmission line 10 configured as a coaxial cable 40 that can include the core 16 defined by the first dielectric material as described above. The first dielectric material of the core 16 of the coaxial cable 40 can be a solid or formed dielectric material, and can be a non-compressible material or a compressible material as desired. In one example, the first dielectric material of the core 16 can be any suitable polymer such as a fluoropolymer. For instance, the first dielectric material can be polytetrafluoroethylen (PTFE). The core 16, and this the coaxial cable 40, can include and electrical signal conductor 34 that is carried by the first dielectric material. In particular, the coaxial cable 40 can include the electrical signal conductor 34 and no other electrical signal conductors, carried by the dielectric material of the core 16. Thus, it can be said that the core 16 includes a single electrical signal conductor.

The electrical signal conductor 34 can extend through the first dielectric material, and can thus be surrounded by the first dielectric material of the core 16. For instance, the electrical signal conductor 34 can extend along the central axis 11. The electrical signal conductor 34 can be referred to as a coaxial signal conductor. The electrical signal conductor 34 can be made from any suitable electrically conductive material, such as a metal or metal alloy, including copper, silver, aluminum, or any combinations thereof or other suitable electrically conductive material.

As described above, the outer core surface 20 can be oval-shaped, racetrack shaped, or otherwise oblong and/or substantially trapezoidal shaped as desired. In one example, the outer core surface 20 can define first and second middle regions 20a opposite each other along the second direction 15, and outer regions 20b that extend outward from the middle regions 20a along the first direction 13. When the outer core surface 20 is racetrack shaped, the middle regions 20a can be substantially flat in cross-section, and can define a substantially straight line in cross-section. Thus, the middle regions 21a can be substantially planar when the central axis 11 is substantially straight and linear. As the outer regions 20b extend away from the middle regions 20a in the first direction, the outer regions 20b can be curved inward toward, and in some examples to, a line or a plane that includes the central axis 11 and is perpendicular to the second direction 15. Respective outer regions 20b on each side of the central axis 11 can meet each other at a line or plane that includes the central axis 11 and is perpendicular to the second direction 15. In other examples, the middle regions 20a can be curved, for instance convex when the outer core surface 20 is oval-shaped.

The coaxial cable 40 can include the first or inner electrical shield 14 that surrounds and circumscribes the core 16 in the manner described above. In particular, the first electrical shield 14 can abut the outer core surface 20. The first electrical shield 14 can be metal that can be wrapped or braided around the core 16, wound around the core 16, or otherwise disposed about the core 16. For instance, the first electrical shield 14 can be angled along the central axis 11 as it is wrapped about the core 16. In particular, the first electrical shield 14 can be wrapped, for instance helically wrapped, about the core 16. Alternatively, the first electrical shield 14 can be concentrically wrapped about the core 16 without being angled along the central axis 11 as it is wrapped. The first electrical shield 14 can define overlapping regions whereby regions of the first electrical shield 14 overlap each other. The electrically conductive material can be a metal. The first electrical shield 14 can be configured as an electrically conductive foil or any suitably alternatively constructed shield. The first shield 14 can be made from any suitable electrically conductive material, such as a metal or metal alloy, such as copper, silver, aluminum, or any combinations thereof. The first shield 14 can define an inner surface 19 that faces the core 16, and an outer surface 21 that is opposite the inner surface 19 and faces away from the core 16.

The first electrical shield 14, including the inner surface 19 and the outer surface 21, can be oval-shaped, racetrack shaped, or otherwise oblong and/or substantially trapezoidal shaped as desired. In one example, the outer surface 21 define first and second middle regions 21a opposite each other along the second direction 15, and outer regions 21b that extend outward from opposed ends of the middle regions 21a along the first direction 13. When the outer surface 21 is racetrack shaped, the middle regions 21a can be substantially flat in cross-section. As the outer regions 21b extend away from the middle regions 21a in the first direction, the outer regions 21b can be curved inward toward, and in some examples to, a line or a plane that includes the central axis 11 and is perpendicular to the second direction 15. Respective outer regions 21b on each side of the central axis 11 can meet each other at a line or plane that includes the central axis 11 and is perpendicular to the second direction 15. When the first electrical shield 14 is disposed about the core 16, the middle regions 21a can extend along the middle regions 20a, respectively, of the core 16, and the outer regions 21b of the first electrical shield 14 can extend along the outer regions 20b, respectively, of the core 16. In other examples, the middle regions 21a can be curved, for instance when the first electrical shield 14 is oval-shaped.

The coaxial cable 40 can include the second or outer electrical shield 18 that can surround, circumscribe, or at least partially circumscribe the first electrical shield 14, and thus the first dielectric material 16 in the manner described above. The first electrical shield 14 can thus be disposed between the first dielectric material 16 and the second electrical shield 18. The second electrical shield 18 can be made from an electrically conductive material, such as a metal or metal alloy, such as copper, silver, aluminum, or any combinations thereof. The second electrical shield 18 can define an inner surface 22 that faces the first electrical shield 14, and an outer surface 25 that is opposite the inner surface 22 and faces the outer jacket 28. In one example, the second electrical shield 18 can define a wrap or a braid as desired. The second electrical shield 18 can define overlapping regions whereby regions of the second electrical shield 18 overlap each other. The second electrical shield 18 can be made from any suitable electrically conductive material, such as a metal or metal alloy, such as copper, silver, aluminum, or any combinations thereof. The second electrical shield 18 can thus be made from the same or a different material than the first electrical shield 14. The second electrical shield 18 can be curved along an entirety of its length. For instance, the inner surface 22 can be concave and the outer surface 25 can be convex. In one example, the second electrical shield 18 can be oval-shaped in cross section. The outer jacket 28 can similarly be oval shaped.

The coaxial cable 40 can further include the electrically insulative outer jacket 28 that surrounds the second electrical shield 18 in the manner described above. In particular, the outer jacket 28 can be in continuous contact with the outer surface 25 of the second electrical shield 18 about an entirety or substantial entirety of the circumference of the outer surface 25. The outer jacket 28 can be an electrically nonconductive polymer, a tape or other suitable electrically non-conductive material. A wound tape can provide compression and can reduce either or both of the width and the height of the signal transmission line 10.

The outer core surface 20 and the outer surface 21 of the first electrical shield 14 can each define, in cross-section, any one of a racetrack, oval, or an otherwise oblong and/or a substantially trapezoidal shape. In particular, the respective widths defined by the outer surfaces 20 and 21 along the first direction 13 is greater than the respective heights defined by the outer core surface 20 and 21 along the second direction 15. Ideally, the second shield 18 can generally be maintained in compression against the first electrical shield 14, such that a portion of the outer surface 21 of the first electrical shield 14 physically touches and remains physically touching an the inner surface 22 of the second electrical shield 18. In other examples, an entirety of the second electrical shield 18 can be spaced from the first electrical shield 14. The first electrical shield 14 can contact a substantial entirety of the outer core surface 20, and can remain in contact with the substantial entirety of the outer core surface 20.

During operation, the second shield 18, or the inner surface 22, of the second shield 18 does not necessarily completely or substantially touch all of the external contours or all of the outer surface 21 of the first shield 14. For instance, the height of the inner surface 22 of the second electrical shield 18 along the second direction 15 can be greater than the height of the outer surface 21 of the first electrical shield 14 along the second direction 15. The width of the inner surface 22 of the second electrical shield 18 along the first direction 13 can be substantially equal to the width of the outer surface 21 of the first electrical shield 14 along the first direction 13. Therefore, the second electrical shield 18 can contact the first electrical shield 14 at opposed outermost first ends of the second electrical shield 18 that are opposite each other along the first direction 13 and aligned with the central axis 11 along the first direction 13, and can be spaced from the first electrical shield 14 at its opposed regions along the second direction 15. Otherwise stated, the regions of the second electrical shield 18 that are opposite each other along the second direction 15 can have a curvature greater than the respective regions of the first electrical shield 14 and the core 16 that are opposite each other along the second direction 15. The distance between the outer surface 21 of the first electrical shield 14 and the inner surface 22 of the second electrical shield 18 along the second direction 15 can be at its maximum at outermost second ends of the second electrical shield 18 that are opposite each other and aligned with the central axis 11 along the second direction 15. The distance between the outer surface 21 of the first electrical shield 14 and the inner surface 22 of the second electrical shield 18 along the second direction can decrease as the inner surface 22 of the second electrical shield 18 extends from the outermost second ends toward the outermost first ends. Further, because the inner surface 22 has a curvature in cross-section greater than that of the outer surface 21, the rate of decrease of the distance between the outer surface 21 and the inner surface 22 increases per unit linear measurement of the inner surface 22 along the first direction 13 as it extends from the second outermost locations to the first outermost locations

The coaxial cable 40 can define the at least one void 24 that extends from the outer surface 21 of the first shield 14 to the inner surface 22 of the second shield 18 at locations whereby the outer surface 21 is spaced from the inner surface 22, as described above. The signal transmission line 10 can define first and second voids 24a and 24b. The first void 24a can be an upper void in the orientation shown in FIG. 3A disposed on one side of the central axis 11 with respect to the second direction 15, and the second void 24b can be a lower void in the orientation shown in FIG. 3A disposed on an opposite side of the central axis 11 with respect to the second direction 15. While the first void 24a is illustrated as an upper void in the orientation shown in FIG. 3A, and the second void 24b is illustrated as a lower void in the orientation shown in FIG. 3A, it is appreciated that the orientation of the signal transmission line 10 can vary during use. The first and second voids 24a-24b can contain air or any suitable gas as desired. The first and second voids 24a and 24b can be separated from each other by abutments of the outer surface 21 of the first electrical shield 14 and the inner surface 22 of the second electrical shield 18 at the outermost first ends of the second electrical shield 18. Alternatively, an entirety of the inner surface 22 of the second electrical shield 18 can be spaced from the outer surface 21 of the first electrical shield 14, and the first and second voids 24a and 24b can be open to each other.

The present inventors have discovered when the first electrical shield 14 is disposed about the core, tension in the first electrical shield 14 can place the first electrical shield 14 under compression against the core 16 at regions whereby the first electrical shield 14 contact the outer regions 20b of the core 16, but can place the first electrical shield 14 under reduced or substantially no compression against the core 16 at regions whereby the first electrical shield extends along the middle regions 20a of the core 16. During operation, the first shield 14 or overlapping regions of the first electrical shield 14 can have a tendency to bunch or slip or define unwanted electrical discontinuities, for instance when the coaxial cable 40 is bent thereby bending the central axis 11, compressed along the second direction 15 or any direction that includes a directional component defined by the second direction 15, or twisted, thereby causing unwanted electrical discontinuities in the first electrical shield 14. The present inventors have discovered that unwanted electrical discontinuities can be caused because the first shield 14 is not under constant compression against the core 16 along an entirety of the length of the first shield 14. In some lower end applications, the electrical cable 38 can still perform well enough electrically during operation of the signal transmission line 10.

However, for higher end applications, the signal transmission performance of the electrical cable 38 can be improved. In particular, the present inventors have solved the technical problem of the unwanted or unintentional unwrapping, kinking, loosening, etc. of the first shield 14, particularly as the signal transmission line 10 is bent, twisted, or otherwise manipulated. For example, the electrical cable 38 can include at least one spacer 26 that is disposed in the at least one void 24, respectively. The at least one spacer 26 can apply a compressive retention force to the first electrical shield 14 against the core 16. The at least one spacer 26 can thus be positioned between the outer surface 21 of the first shield 14 and the inner surface 22 of the second shield 18. For instance, the at least one spacer can extend from the outer surface 21 of the first shield 14 to the inner surface 22 of the second shield 18. Thus, the at least one spacer 26 can directly abut the outer surface 21 of the first shield 14 and the inner surface 22 of the second shield 18. It can also be said that each spacer 26 is positioned between the outer core surface 20 of the first shield 14 and the outer electrically insulative jacket 28. Further, the first shield 14 can be positioned between the core 16 and each spacer 26. It can further be said that the second shield 18 is positioned between each spacer 26 and the electrically insulative jacket 28. In alternative examples, the signal transmission line 10 can be devoid of the second shield, such that each spacer 26 directly abuts the outer jacket 28. In still alternative examples, intermediate structure can be disposed between the outer surface 21 of the first shield 14 and each spacer 26 and/or between the inner surface 22 of the second shield 18 and each spacer 26.

For instance, the at least one spacer 26 can include the first spacer 26a disposed in the first void 24a, and the second spacer 26b disposed in the second void 24b. Each spacer 26 can bear against and thus provide a force against the inner electrical shield 14, and in particular the outer surface 21 of the inner electrical shield 14, and the outer electrical shield 18, and in particular the inner surface 22 of the outer electrical shield 18. For instance, the outer jacket 28 can apply a respective radial compressive force to the second electrical shield 18, which in turn urges each spacer 26 to apply a respective radial compressive force to the first electrical shield 14. Each spacer 26 can apply a force or a compression force or a constant force or a continuous force onto the first shield 14, for instance onto the outer surface 21 of the first shield. In some examples, the first and second spacers 26a and 26b can be mirror images of each other. Alternatively, the first and second spacers 26a and 26b can have respective sizes and/or shapes that are different from each other. The first and second spacers 26a and 26b can be aligned with each other and the central axis 11 along the second direction 15. The central axis 11 can be disposed between the first and second spacers 26a and 26b with respect to the second direction 15.

Each spacer 26 can be defined by any suitable material such as a solid material, a discrete material, a discrete solid material, an elastomeric material, a discrete elastomeric material, or any combination thereof can be positioned in the respective void 24. In one example, each spacer 26 can be electrically nonconductive. In other examples, each spacer 26 can be electrically conductive. In still other examples, each spacer can include both electrically conductive material and electrically nonconductive material. Each spacer 26 can be mechanically non-compressible or mechanically compressible during normal use of the signal transmission line 10, for instance when the signal transmission line 10 is bent. Each spacer 26 can define a single monolithic structure that extends from the outer surface 21 of the first electrical shield 14 to the inner surface 22 of the second electrical shield 18. Each spacer 26 of the first and second spacers 26a-26b can define a middle region with respect to the first direction 13, and opposed end regions that extend from the middle region in opposite directions along the second direction 15 to respective outed ends of the spacer 26. The end regions can be substantial mirror images of each other. Each spacer 26 can have a thickness along the second direction 15 at the middle region, and respective thickness of each of the end regions along the second direction 15. The thickness at the middle region can be greater than the thickness of each of the end regions along the second direction 15. In particular, the maximum thickness at the middle region is greater than the maximum thicknesses at each of the end regions.

Each spacer 26 can be compressed against the outer core surface 20 of the first shield 14 by the second shield 18, the outer jacket 28 or both. That is, each spacer 26 can bear directly against the metallic outer surface 21 of the first electrical shield 14. Each spacer 26 can further bear directly against the metallic inner surface 22 of the second electrical shield 18. Each spacer 26 can retain its original shape. Alternatively, as the signal transmission line 10 is bent, twisted, and or compressed along a direction perpendicular to the central axis 11, each spacer 26 can be compliant and can deform to extend into one or more locations of the void 24 previously unoccupied by the spacer 26. In general, each spacer 26 can maintain a constant or at least a continuous force on the outer core surface 20 of the first shield 14 so as to prevent or reduce separation, kinking, twisting, or slipping of the associated wrappings of the first shield 14 with respect to one another. In particular, the force from each spacer 26 can urge select wrappings 39 of the first shield 14 against adjacent wrappings 41 that are disposed inward of the select wrappings 39 (see FIG. 1D). In some examples, the adjacent wrappings 41 can be disposed between the select wrappings and the core 16. This reduction or prevention of unwanted loosening of the first electrical shield 14 helps to eliminate unwanted electrical discontinuities along a length of the signal transmission line 10.

Each spacer 26 of the coaxial cable 40 can occupy a portion of the respective void 24 less than an entirety of the respective void 24. In particular, the end regions of each spacer 26 can terminate inward of the ends of the respective void 24 with respect to the first direction 13. Each spacer 26 can be configured as a localized spacer as described above with respect to FIG. 1C. Each spacer 26 can define a first or inner surface 27a and a second or outer surface 27b opposite the first surface 27a. The first surface 27a can face the outer surface 21 of the first electrical shield 14, and the second surface 27b can face the inner surface 22 of the second electrical shield 18. Further, the first surface 27a can follow the contour of the outer surface 21 of the first electrical shield 14, and the second surface 27b can follow the contour of the inner surface 22 of the second electrical shield 18. Thus, the first surface 27a can be substantially flat, for instance when the outer core surface 20 of the first dielectric material 16 is racetrack shaped. In other examples, for instance, when the outer core surface 20 is oval shaped, the first surface 27a can be concave. The second surface 27b can be convex.

It should be appreciated that the coaxial cable 40 can be constructed in accordance with any suitable alternative example as desired. For instance, in one alternative example, as shown in FIG. 3B, the spacer 26 of the coaxial cable 40 can be configured as a filler spacer described above with respect to FIG. 1E. In another example shown in FIG. 3C, the coaxial cable 40 can be circular in cross-section. Thus, the outer jacket 28 can be circular in cross-section, and the second shield 18, including the inner and outer surfaces 22 and 25, can be circular in cross-section. The first or inner dielectric 16 can be oval-shaped, racetrack shaped, or otherwise oblong and/or substantially trapezoidal shaped as described above. The first shield 14 can similarly be oval-shaped, racetrack shaped, or otherwise oblong and/or substantially trapezoidal shaped as described above. Each spacer 26 can be disposed between the first shield 14 and the second shield, and can be configured as a localized spacer as described above with respect to FIGS. 1C and 2A. Alternatively, each spacer 26 can be configured as a filler spacer as described above with respect to FIGS. 1E and 3B.

Referring now to FIG. 3D, and as described above, the signal transmission line 10 can be configured as an electrical cable 38, and in particular a twinaxial cable 42. The twinaxial cable 42 of FIG. 3D can be constructed as described above with respect to the coaxial cable 40 of FIG. 3A. However, the core 16, and thus the twinaxial cable 42, includes first and second electrical signal conductors 34 and 36 that are supported by the first dielectric material of the core 16. In particular, the first dielectric material of the core 16 can surround each of the first and second electrical conductors 34 and 36. The first and second electrical conductors can be aligned with each other along the first direction 13. Further, the first and second electrical conductors can define a differential signal pair. Alternatively, the first and second electrical conductors can be single ended. The twin axial cable 42 is otherwise as described above with respect to the coaxial cable 40 of FIG. 3A. The spacer 26 of the electrical cable 38 of FIG. 3D can be configured as a localized spacer as described above with respect to FIGS. 1C, 3A, and 3C.

It should be appreciated that the twinaxial cable 42 can be constructed in accordance with any suitable alternative example as desired. For instance, in one alternative example, as shown in FIG. 3E, the spacer 26 of the twinaxial cable 42 can be configured as a filler spacer as described above with respect to FIGS. 1C and 3B. It should be appreciated that the electrical cables 38 of FIGS. 3A-3E can be devoid of drain wires that extend the length of the electrical cable. In both examples of the twinaxial cable 42 and the coaxial cable 40, data signals in the form of electrical travel through the core 16, and in particular along the at least one electrical signal conductor that extends through the first dielectric material of the core 16. Further, it should be appreciated that the core 16 of the electrical cables 38 of FIGS. 3A-3E can be configured as a substantially rectangular core as described above with respect to FIGS. 1F-1G, and the first electrical shield 14 of the electrical cables 38 of FIGS. 3A-3E can be configured as a substantially rectangular first electrical shield 14 as described above with respect to FIGS. 1F-1G.

It should be appreciated that the illustrations and discussions of the embodiments shown in the figures are for exemplary purposes only and should not be construed limiting the disclosure. One skilled in the art will appreciate that the present disclosure contemplates various embodiments. Additionally, it should be understood that the concepts described above with the above-described embodiments may be employed alone or in combination with any of the other embodiments described above. It should be further appreciated that the various alternative embodiments described above with respect to one illustrated embodiment can apply to all embodiments as described herein, unless otherwise indicated.

1. A flexible signal transmission line comprising:
a core comprising a dielectric material, the core defining an outer surface;
a first electrical shield that surrounds the outer surface of the core;
an outer electrically insulative jacket; and
a spacer disposed between the outer electrically insulative jacket and the first electrical shield,
wherein the spacer is configured to apply a compressive force to the first electrical shield toward the core.

2. The signal transmission line of claim 1, wherein the spacer defines a first surface that faces the first electrical shield, and a second surface opposite the first surface, wherein the second surface is convex.

3. The signal transmission line of claim 2, wherein the first surface of the spacer is substantially flat.

4. The signal transmission line of claim 1, wherein the core and the first electrical shield are racetrack shaped.

5. The signal transmission line of claim 1, wherein the shield comprises select wrappings and adjacent wrappings disposed between the select wrappings and the core, and the spacer contacts the select wrappings to apply a force to the select wrappings against the adjacent wrappings.

6. The signal transmission line of claim 1, wherein the shield defines an inner surface that faces the core and an outer surface opposite the inner surface, and the spacer abuts the outer surface of the shield.

7. The signal transmission line of claim 1, wherein the shield comprises a metal.

8. The signal transmission line of any one of claim 1, further comprising a second electrical shield disposed between the spacer and the outer electrically insulative jacket.

9. The signal transmission line of claim 8, wherein an entirety of the spacer that extends from the first electrical shield to the second electrical shield is a monolithic structure.

10. The signal transmission line of claim 8, wherein the core is elongate along a central axis, and a void is defined between an outer surface of the first shield and an inner surface of the second electrical shield, and the spacer is disposed in the void on one side of the central axis.

11-14. (canceled)

15. The signal transmission line of claim 10, wherein the spacer deforms to fill in all or some of the void.

16-18. (canceled)

19. The signal transmission line of claim 10, wherein the spacer is electrically insulative.

20. The signal transmission line of claim 10, wherein the void comprises first and second voids, and the spacer comprises first and second spacers disposed in the first and second voids, respectively, that are disposed on opposite sides of the central axis.

21-22. (canceled)

23. The signal transmission line of claim 10, defining a first direction perpendicular to the central axis and a second direction perpendicular to each of the first direction and the central axis,
wherein the core is a substantially rectangular core having an outer core surface that defines a first pair of surfaces that are substantially linear in cross-section and on opposite sides of the central axis with respect to the second direction, and a second pair of surfaces that are substantially linear in cross-section and on opposite sides of the central axis with respect to the first direction, and
wherein the void comprises first and second voids opposite each other along the second direction, and third and fourth voids opposite each other along the first direction.

24. (canceled)

25. The signal transmission line of any one of claim 23, wherein the spacer comprises a first spacer disposed in the first void, a second spacer disposed in the second void, a third spacer disposed in the third void, and a fourth spacer disposed in the fourth void, and each of the spacers apply a compressive force to the first electrical shield against the core.

26-27. (canceled)

28. The signal transmission line of claim 23, wherein the core is a dielectric core comprising only a solid or formed dielectric material.

29-35. (canceled)

36. The signal transmission line of claim 1, comprising a waveguide.

37. The signal transmission line of claim 36, wherein the core is a hollow core comprising an outer wall that defines a hollow channel, and the hollow channel contains a gas.

38. (canceled)

39. The signal transmission line of claim 37, wherein the waveguide is devoid of supports in the hollow channel.

40. The signal transmission line of claim 36, wherein the core is a semi-hollow core defining first and second hollow channels that each contain a gas.

41. (canceled)

42. The signal transmission line of claim 1, wherein the signal transmission line is a coaxial electrical cable comprising a single electrical signal conductor that is surrounded by the dielectric material.

43. The signal transmission line of claim 1, wherein the signal transmission line is a twinaxial electrical cable comprising first and second electrical signal conductors that are surrounded by the dielectric material.

44-45. (canceled)

46. The signal transmission line of claim 1, wherein each spacer is a localized spacer that occupies greater than approximately 20 percent of the respective void 24 and less than approximately 80 percent of the void 24.

47. The signal transmission line of claim 1, wherein each spacer is a filler spacer that occupies greater than approximately 80 percent of the void 24.

48. (canceled)
